(19) United States
(12) Patent Application Publication
(10) Pub. No.: US 2011/0235464 A1
(43) Pub. Date: Sep. 29, 2011

(54) Method of imaging the earth's subsurface during marine seismic data acquisition

(76) Inventors: John Brittan, Weybridge (GB); Stephen David Bishop, Farham (GB); Sverre Brandsberg-Dahl, Houston, TX (US)

(21) Appl. No.: 12/661,785

(22) Filed: Mar. 24, 2010

(51) Int. Cl. G01V 1/34

(52) U.S. Cl. 367/72

(57) ABSTRACT

Marine seismic data are acquired, using a seismic vessel. The acquired marine seismic data are transferred in near-real time to a programmable computer. The programmable computer is used to perform the following. An acoustic 3-D full-waveform inversion is applied to the transferred marine seismic data, generating a high-resolution 3-D velocity field in near-real time. The velocity field is used to apply migration to the transferred marine seismic data, generating an image of the earth's subsurface in near-real time.

### CROSS-REFERENCES TO RELATED APPLICATIONS

Not Applicable

### FEDERALLY SPONSORED RESEARCH OR DEVELOPMENT

Not Applicable

### SEQUENCE LISTING, TABLE, OR COMPUTER LISTING

Not Applicable

### BACKGROUND OF THE INVENTION

1. Field of the Invention

This invention relates generally to the field of geophysical prospecting. More particularly, the invention relates to the field of imaging marine seismic data.

2. Description of the Related Art

In the oil and gas industry, geophysical prospecting is commonly used to aid in the search for and evaluation of subsurface earth formations. Geophysical prospecting techniques yield knowledge of the subsurface structure of the earth, which is useful for finding and extracting valuable mineral resources, particularly hydrocarbon deposits such as oil and natural gas. A well-known technique of geophysical prospecting is a seismic survey. In a land-based seismic survey, a seismic signal is generated on or near the earth's surface and then travels downward into the subsurface of the earth. In a marine seismic survey, the seismic signal may also travel downward through a body of water overlying the subsurface of the earth. Seismic energy sources are used to generate the seismic signal which, after propagating into the earth, is at least partially reflected by subsurface seismic reflectors. Such seismic reflectors typically are interfaces between subterranean formations having different elastic properties, specifically sound wave velocity and rock density, which lead to differences in acoustic impedance at the interfaces. The reflected seismic energy is detected by seismic sensors (also called seismic receivers) at or near the surface of the earth, in an overlying body of water, or at known depths in boreholes. The seismic sensors generate signals, typically electrical or optical, from the detected seismic energy, which are recorded for further processing.

The resulting seismic data obtained in performing a seismic survey, representative of earth's subsurface, are processed to yield information relating to the geologic structure and properties of the subsurface earth formations in the area being surveyed. The processed seismic data are processed for display and analysis of potential hydrocarbon content of these subterranean formations. The goal of seismic data processing is to extract from the seismic data as much information as possible regarding the subterranean formations in order to adequately image the geologic subsurface. In order to identify locations in the earth's subsurface where there is a probability for finding petroleum accumulations, large sums of money are expended in gathering, processing, and interpreting seismic data. The process of constructing the reflector surfaces defining the subterranean earth layers of interest from the recorded seismic data provides an image of the earth in depth or time.

The image of the structure of the earth's subsurface is produced in order to enable an interpreter to select locations with the greatest probability of having petroleum accumulations. To verify the presence of petroleum, a well must be drilled. Drilling wells to determine whether petroleum deposits are present or not, is an extremely expensive and time-consuming undertaking. For that reason, there is a continuing need to improve the processing and display of the seismic data, so as to produce an image of the structure of the earth's subsurface that will improve the ability of an interpreter, whether the interpretation is made by a computer or a human, to assess the probability that an accumulation of petroleum exists at a particular location in the earth's subsurface.

The appropriate seismic sources for generating the seismic signal in land seismic surveys may include explosives or vibrators. Marine seismic surveys typically employ a submerged seismic source towed by a seismic vessel and periodically activated to generate an acoustic wavefield. The seismic source generating the wavefield may be of several types, including a small explosive charge, an electric spark or arc, a marine vibrator, and, typically, a gun. The seismic source gun may be a water gun, a vapor gun, and, most typically, an air gun. Typically, a marine seismic source consists not of a single source element, but of a spatially-distributed array of source elements. This arrangement is particularly true for air guns, currently the most common form of marine seismic source.

The appropriate types of seismic sensors typically include particle velocity sensors, particularly in land surveys, and water pressure sensors, particularly in marine surveys. Sometimes particle acceleration sensors or pressure gradient sensors are used in place of or in addition to particle velocity sensors. Particle velocity sensors and water pressure sensors are commonly known in the art as geophones and hydrophones, respectively. Seismic sensors may be deployed by themselves, but are more commonly deployed in sensor arrays. Additionally, pressure sensors and particle velocity sensors are often deployed together in a marine survey, collocated in pairs or pairs of arrays.

In a typical marine seismic survey, a seismic survey vessel travels on the water surface, typically at about 5 knots, and contains seismic acquisition equipment, such as navigation control, seismic source control, seismic sensor control, and recording equipment. The seismic source control equipment causes a seismic source towed in the body of water by the seismic vessel to actuate at selected times. Seismic streamers, also called seismic cables, are elongate cable-like structures towed in the body of water by the seismic survey vessel that tows the seismic source or by another seismic survey vessel. Typically, a plurality of seismic streamers are towed behind a seismic vessel. The seismic streamers contain sensors to detect the reflected wavefields initiated by the seismic source and reflected from reflecting interfaces. Conventionally, the seismic streamers contain pressure sensors such as hydrophones, but seismic streamers are utilized that contain water particle velocity sensors such as geophones or particle acceleration sensors such as accelerometers, in addition to hydrophones. The pressure sensors and particle motion sensors are typically deployed in close proximity, collocated in pairs or pairs of arrays along a seismic cable.

Constructing an image of the earth's subsurface increases in value if the image is constructed quickly enough to be available during the seismic data acquisition. The images can be used to correct errors in previous data acquisition and direct subsequent data acquisition. These benefits are particularly valuable in offshore marine seismic data acquisition, where delays in redoing data acquisition are extremely expensive. The time delay between the acquisition of the offshore data and the construction of the image of the earth's subsurface is due to the time spent in data transmission and data processing, and is called “near-real time”. The term “near-real time” also refers to a situation in which the time delay due to transmission and processing is insignificant, so that near-real time approximates real time, the time when acquisition occurs. In the present context, near-real time will refer to a time delay that is short enough to allow timely use of the processed data images during further data acquisition.

Thus, a need exists for a method for constructing an image of the earth's subsurface in near-real time during offshore seismic data acquisition. This near-real time imaging further requires a method for determining a high-resolution velocity field in near-real time during offshore seismic data acquisition.

### BRIEF SUMMARY OF THE INVENTION

The invention is a method for constructing an image of earth's subsurface from marine seismic data in near-real time. Marine seismic data are acquired, using a seismic vessel. The acquired marine seismic data are transferred in near-real time to a programmable computer. The programmable computer is used to perform the following. An acoustic 3-D full-waveform inversion is applied to the transferred marine seismic data, generating a high-resolution 3-D velocity field in near-real time. The velocity field is used to apply migration to the transferred marine seismic data, generating an image of the earth's subsurface in near-real time.

### BRIEF DESCRIPTION OF THE DRAWINGS

The invention and its advantages may be more easily understood by reference to the following detailed description and the attached drawings, in which:

FIG. 1 is a flowchart illustrating an embodiment of the invention for deriving a high-resolution 3-D velocity field from marine seismic data in near-real time;

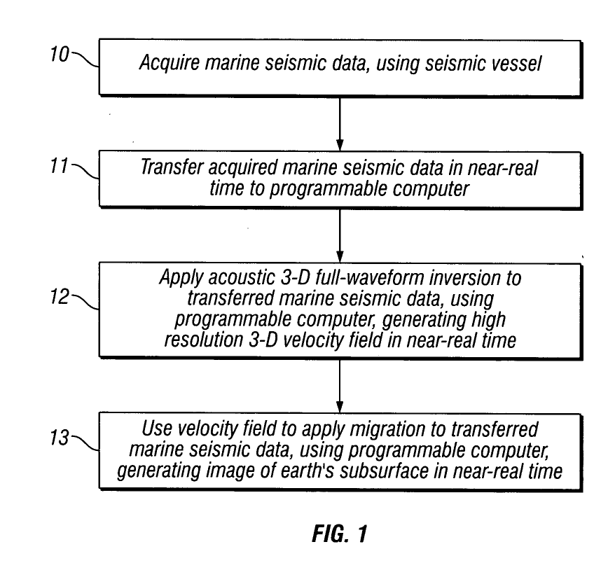

FIG. 2 is a flowchart illustrating an embodiment of the invention for deriving a high-resolution 3-D velocity field from marine seismic data in near-real time with onshore processing; and

FIG. 3 is a flowchart illustrating an embodiment of the invention for deriving a high-resolution 3-D velocity field from marine seismic data in near-real time with onboard processing.

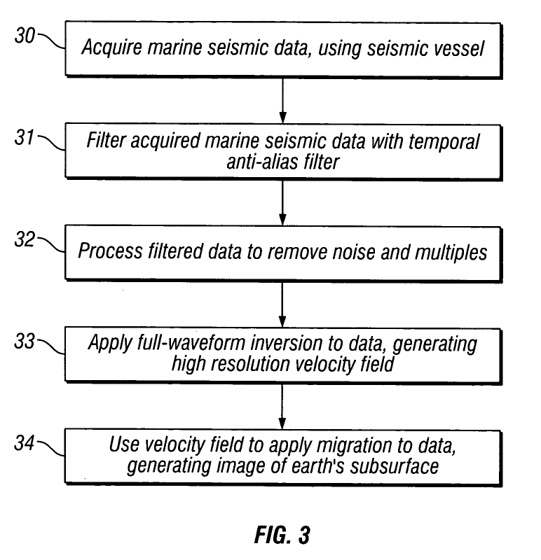

While the invention will be described in connection with its preferred embodiments, it will be understood that the invention is not limited to these. On the contrary, the invention is regarding the flowchart in FIG. 3, the programmable computer is located onboard the seismic vessel.

At block 12, an acoustic 3-D full-waveform inversion is applied to the marine seismic data transferred in block 11, using the programmable computer from block 11, generating a high-resolution 3-D velocity field in near-real time.

At block 13, the velocity field generated in block 12 is used to apply migration to the marine seismic data transferred in block 11, using the programmable computer from block 11, generating an image of the earth's subsurface in near-real time.

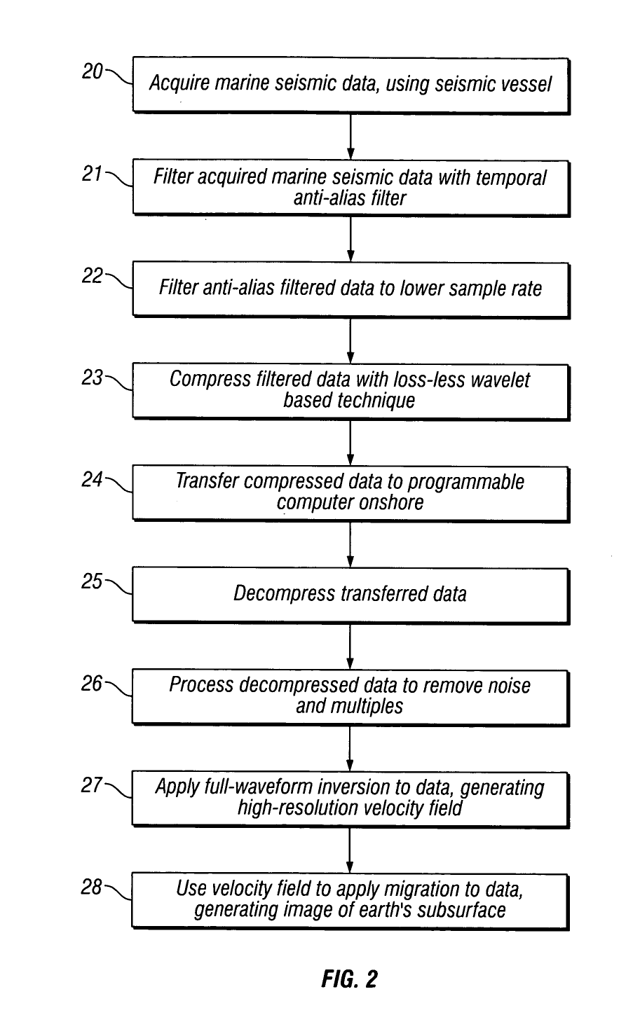

FIG. 2 is a flowchart illustrating an embodiment of the invention for constructing an image of earth's subsurface from marine seismic data in near-real time with onshore processing.

At block 20, marine seismic data are acquired, using a seismic vessel. Typically, the marine seismic, data is acquired employing marine seismic sources and marine seismic receivers, as described above in the Background section. The positions of the seismic sources at each source activation and the positions of the seismic receivers at each seismic signal detection are determined by the acquisition system and incorporated into the seismic data.

At block 21, the marine seismic data acquired in block 20 are filtered with a temporal anti-alias filter. The temporal anti-alias filter is designed to prevent leakage of noise in the sample rate filtering in block 22 below. In addition, the temporal anti-alias filter is designed to optimize the signal-to-noise ratio in the lower frequency portion of the marine seismic data, for the full-waveform inversion in block 27 below.

At block 22, the data filtered in block 21 are further filtered to a lower sample rate. This lower sample rate is designed to be sufficiently low to facilitate a ship-to-shore data transfer rate in block 24 below that is quick enough to allow the invention to be practiced in near-real time.

At block 23, the filtered data filtered further in block 22 are compressed, In one embodiment, this compression employs a loss-less wavelet based technique. As above, this compression is to facilitate a quick ship-to-shore data transfer rate in block 24 below.

At block 24, the filtered data compressed in block 23 are transferred to a processing center onshore. The filtering in block 22 and compression in block 23 speed up the transfer rate to match the seismic data acquisition rate. Thus, in one embodiment, the seismic data from one shot are transferred during the shooting of the subsequent shot. limited to, beam migration, Kirchhoff migration, and reverse-time migration. Employing the invention described here, the image of the subsurface can be provided in near-real time.

In a further embodiment, the velocity field generated in either block 27 of FIG. 2 or block 33 of FIG. 3 is employed in a seismic inversion process to estimate rock properties of the earth's subsurface. Seismic inversion transforms seismic reflection data into the rock properties. The seismic inversion can be constrained by other data, such as well data. The near-real time acquisition and high-resolution of the velocity fields improves the results of seismic inversion.

The invention has been discussed above as a method, for illustrative purposes only, but can also be implemented as a system. The system of the invention is preferably implemented by means of computers, in particular digital computers, along with other conventional data processing equipment. Such data processing equipment, well known in the art, will comprise any appropriate combination or network of computer processing equipment, including, but not be limited to, hardware (processors, temporary and permanent storage devices, and any other appropriate computer processing equipment), software (operating systems, application programs, mathematics program libraries, and any other appropriate software), connections (electrical, optical, wireless, or otherwise), and peripherals (input and output devices such as keyboards, pointing devices, and scanners; display devices such as monitors and printers; computer readable storage media such as tapes, disks, and hard drives, and any other appropriate equipment).

In another embodiment, the invention could be implemented as the method described above, specifically carried out using a programmable computer to perform the method. In another embodiment, the invention could be implemented as a computer program stored in a computer readable medium, with the program having logic operable to cause a programmable computer to perform the method described above. In another embodiment, the invention could be implemented as a computer readable medium with a computer program stored on the medium, such that the program has logic operable to cause a programmable computer to perform the method described above.

It should be understood that the preceding is merely a detailed description of specific embodiments of this invention and that numerous changes, modifications, and alternatives to the disclosed embodiments can be made in accordance with the disclosure here without departing from the scope of the invention. The preceding description, therefore, is not meant to limit the

We claim:

1. A method for constructing an image of earth's subsurface from marine seismic data in near-real time, comprising:
acquiring marine seismic data, using a seismic vessel;
transferring the acquired marine seismic data in near-real time to a programmable computer; and
using the programmable computer to perform the following:
applying an acoustic 3-D full-waveform inversion to the transferred marine seismic data, generating a high-resolution 3-D velocity field in near-real time; and
using the velocity field to apply migration to the transferred marine seismic data, generating an image of the earth's subsurface in near-real time.

2. The method of claim 1, wherein the programmable computer is onboard the seismic vessel.

3. The method of claim 2, wherein the transferring the acquired marine seismic data further comprises:
using the programmable computer to perform the following:
processing the transferred data to remove noise and multiples.

4. The method of claim 1, wherein the programmable computer is onshore.

5. The method of claim 4, wherein the acquiring marine seismic data further comprises:
using a programmable computer onboard the seismic vessel to perform the following:
filtering the acquired marine seismic data with a temporal anti-alias filter;
further filtering the filtered data to a lower sample rate; and
compressing the filtered data.

6. The method of claim 5, wherein the transferring the acquired marine seismic data further comprises:
using the programmable computer onshore to perform the following:
decompressing the transferred data; and
processing the decompressed data to remove noise and multiples.

7. The method of claim 5, wherein the temporal anti-alias filter is designed to optimize signal-to-noise ratio in a lower frequency portion of the marine seismic data.

8. The method of claim 5, wherein the temporal anti-alias filter is designed to prevent leakage of noise in the sample rate filtering.

9. The method of claim 5, wherein the compressing employs a loss-less wavelet based technique.

10. The method of claim 1, further comprising:
using the velocity field in a seismic inversion process to estimate rock properties of the earth's subsurface.
